(19) United States
(12) Patent Application Publication
(10) Pub. No.: US 2026/0168596 A1
(43) Pub. Date: Jun. 18, 2026

(54) SLIDING CONTACT FOR A HIGH-PRESSURE HOSE FOR A CLEANING HEAD WITH VIDEO CAMERA

(71) Applicant: ENZ TECHNIK AG, Giswil (CH)

(72) Inventor: Christoph LENDI, Giswil (CH)

(21) Appl. No.: 19/412,242

(22) Filed: Dec. 8, 2025

(30) Foreign Application Priority Data
Dec. 13, 2024 (CH) CH001384/2024

(51) Int. Cl. F16L 3/18; B08B 9/04; F16L 55/40; F16L 101/12; F16L 101/30

(52) U.S. Cl. CPC F16L 3/18; B08B 9/04; F16L 55/40; F16L 2101/12; F16L 2101/30

(57) ABSTRACT

A one-piece sliding contact, which can be used in a multifunctional high-pressure hose of a device for inspecting and cleaning pipes and pipes, includes a guide eye and a stabilization chamber of one material. The guide eye has a centric guide eye through hole with a central axis, and the stabilization chamber has a recess configured as a blind hole running along a central axis of the stabilization chamber, wherein both central axes are spaced parallel to each other in a transverse direction.

### REFERENCE TO RELATED APPLICATION

This application claims priority to Switzerland Application Serial No. CH001384/2024, filed Dec. 13, 2024, which is incorporated in its entirety by reference herein.

### TECHNICAL FIELD

Embodiments of the present invention relate generally to devices and systems for inspecting and cleaning equipment, and more particularly to a sliding contact, which can be used in a multifunctional high-pressure hose of a device for examining and cleaning pipes and pipes, as well as a multifunctional high-pressure hose of a device for examining and cleaning pipes and pipes, at one end of which a cleaning head with nozzles and an observation unit with illumination and camera can be attached, wherein the high-pressure hose is an inner hose, and has a metal mesh and an outer shell.

### BACKGROUND

A device for inspecting and cleaning pipes and pipes is known from EP2502681. Such devices are equipped with a cleaning head arranged at the end of a multifunctional high-pressure hose, to which a camera is also attached for inspection.

A cleaning head for sewer cleaning equipment is attached to a high-pressure hose, with the high-pressure hose playing a central role in the system. In FIG. 1, the details of interest here are shown and labeled according to the state of the art. This high-pressure hose, typically ⅜ inch in diameter for small pipes, is multi-layered, with an inner hose 21 surrounded by a metal braid 22, surrounded by a protective outer sheath 23. This combination is necessary to achieve the necessary resistance to high pressures of 100 bar and more.

The special feature is the integration of an inner conductor 24 in the high-pressure hose. This inner conductor 24, together with the metal mesh 22 as the outer conductor, forms a coaxial cable. This design enables the transmission of signals, especially high-frequency signals for image transmission, as well as the power supply to the cleaning head.

The inner conductor 24 in the inner hose compartment does not obstruct the water flow. The signal is transmitted by modulation to different carrier frequencies. The camera's image signal is modulated to a first carrier frequency, while control signals are mapped to a second carrier frequency. The energy supply is preferably with direct current to minimize interference. The camera plays an important role in controlling and documenting cleaning. It is mounted on the cleaning head and is mainly activated at branches or bends to check the correct positioning and movement of the cleaning head. A lighting device ensures sufficient visibility in the dark tubes. The camera can also be used to inspect the cleaned pipe and document damage.

A contact ring 31 for the inner conductor 24, which is arranged in a connector 32 at the end of the high-pressure hose, is used for secure contact between the high-pressure hose and the cleaning head. At the other end of the high-pressure hose, an intermediate piece leads the contacts outwards, typically as a coax socket. The transmitted signals are routed to a control unit that can display and record the camera signals and control the functions of the cleaning head. An incremental encoder on the hose reel can detect the insertion length, which is used to determine the position in the pipe.

This innovative design enables efficient pipe cleaning with simultaneous inspection and precise control. The multifunctional high-pressure hose with integrated coaxial cable forms the backbone of the system, while the camera provides visual control and documentation. This greatly improves the efficiency and accuracy of sewer cleaning operations.

The inner conductor 24 is arranged within the inner hose 21 in the edge area of the interior of the inner hose 21. This means that the inner conductor 24 does not interfere with the cleaning fluid. The inner conductor 24 is only attached to the contact ring 31 in connector 32 at the end of the high-pressure hose facing the cleaning head.

In practice, such a connection leads to problems if the high-pressure hose is often guided around extreme curves in the cleaning and inspection process. The inner conductor 24 is subjected to extreme stress and can tear and thus interrupt signal transmission. The inner conductor 24 can withstand any extreme bending of the high-pressure hose, and so far it has not been possible to prevent the inner conductor 24 from being damaged after only a short period of use.

### SUMMARY

One or more disadvantages described above from the prior art can be reduced or eliminated by the present device.

An example high-pressure hose according to embodiments herein can be configured in such a way that a more robust inner conductor is achieved, which is more durable and thus more durable.

In an embodiment, a sliding contact that can be used in a multifunctional high-pressure hose of a device for inspecting and cleaning pipes and pipes is provided. The sliding contact is one-piece and comprises a guide eye and a stabilization chamber made of one material. The guide eye has a centric guide eye through hole with a central axis and a length, and the stabilization chamber has a recess designed as a blind hole running along a central axis of the stabilization chamber. Both central axes are spaced parallel to each other in a transverse direction, so that an inner conductor can be attached to the stabilization chamber and a free inner conductor can be passed through the guide eye.

In an additional embodiment, a multifunctional high-pressure hose of a device for examining and cleaning pipes and pipes is provided, at one end of which a cleaning head with nozzles and an observation unit with illumination and camera can be attached. The high-pressure hose includes an inner hose, a metal braid, and an outer sheath, and has a one-piece sliding contact as provided herein. An inner conductor is fixed in the stabilization chamber of the sliding contact, and the inner conductor is mounted within the inner hose by guiding the sliding contact by means of a free inner conductor through the guide eyelet through hole of the guide eye within the inner hose, whereby kinking is prevented when the high-pressure hose is bent.

Variations of feature combinations or minor adjustments to the invention can be found in the detailed description, are shown in the figures and have been included in one or more dependent claims.

### BRIEF DESCRIPTION OF THE DRAWINGS

A preferred embodiment of the subject-matter of the invention is described below in connection with the attached drawings in the detailed description.

Further features, details and advantages of the invention can also be found in the following description of slightly modified versions of the invention, which is partly clear to the skilled person from the drawings alone. They are depicted in

FIG. 1 shows a schematic sectional view of a high-pressure hose end known from the prior art, whereby the multifunctional high-pressure hose is designed as a coaxial cable.

FIG. 2 shows a schematic sectional view of a part of the high-pressure hose according to a present embodiment, with a sliding contact for guiding a free or loose inner conductor.

FIG. 3a shows a perspective view of the sliding contact with two different distances and axes with an implied inner conductor, while

FIG. 3b shows a view of the sliding contact in the direction of a guide eye.

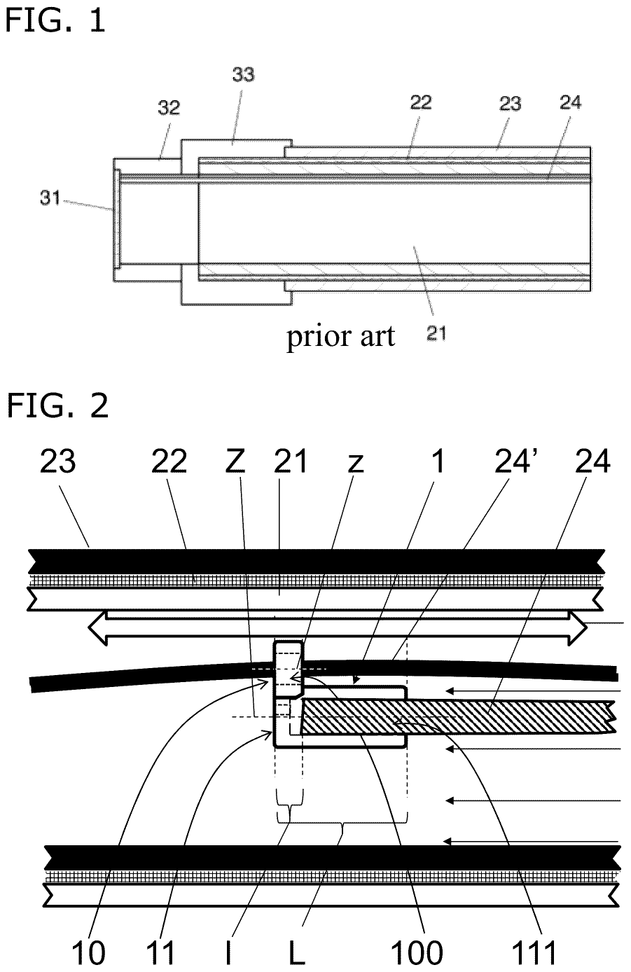

### DETAILED DESCRIPTION

Since only a multifunctional high-pressure hose of a device for examining and cleaning pipes and pipes is decisive here, this device including a cleaning head with nozzles for propulsion and cleaning, as well as the observation unit with lighting and camera is omitted from the illustrations and the detailed description. These components of the device are known from the state of the art in some variants.

As known from the state of the art, the multifunctional high-pressure hose has a multi-layer design and has an outer shell 23, a metal braid 22 and an inner hose 21.

A sliding contact 1 is arranged within the inner hose 21, to which an inner conductor 24 is attached. In contrast to the fixed inner conductor 24, a free or loose inner conductor 24′ is at least partially arranged within the interior of the inner tube 21. The sliding contact 1 can move, as marked with the white double arrow.

The sliding contact 1 is single-piece, made of one material and has two components: a guide eye 10 and a stabilization chamber 11. The one-piece sliding contact 1 is preferably made of a corrosion-resistant metal, preferably stainless steel, especially preferably of V4A steel.

The metal braid 22, the free inner conductor 24′ and the inner conductor 24 form a coax cable, which is used for energy and signal transmission within the device. For example, the loose inner conductor 24′ is attached to a connector 32, which is attached to the high-pressure hose with a crimping sleeve 33, as is known from the state of the art. By using the sliding contact 1, the total inner conductor 24, 24′ can practically vary in length without tearing or being damaged, even if the high-pressure hose is guided around corners. In particular, contact can be made via the contact ring 31 or, for example, by means of a spring attachment. The inner conductor 24 is subjected to less stress even with strong hose bends. The distance between the inner conductor 24′ and the inner tube 21 and, above all, the metal mesh 22 is maintained at all times.

To protect the two inner conductors 24, 24′ against cracks or general destruction, the inner conductor 24′ is guided in the interior of the inner hose 21 by means of the sliding contact 1 at a distance from the wall of the inner hose 21. The inner conductor 24, which is fixed in the sliding contact 1, the sliding contact 1 and the free inner conductor 24′ are, as indicated by the parallel arrows, washed around by cleaning fluid, usually water.

The guide eye 10 is designed in a ring, with a centric guide eye through hole 100, which is recessed parallel to a central axis z, with the guide eye having a length l. The free inner conductor 24′ is guided through the guide eye through hole 100, as shown in FIG. 2.

Connected to the guide eye 10, the stabilization chamber 11 is offset parallel to a transverse direction of the sliding contact 1. Stabilization chamber 11 has a recess 111 along a central axis Z of stabilization chamber 11, with recess 111 forming a blind hole. Thus, the depth of the recess 111 does not correspond to the length L of the stabilization chamber 11.

The sliding contact 1 thus has only one stabilization chamber 11, whereby the central axis z parallel to the central axis Z and thus the guide eye through hole 100 and the recess 111 of the stabilization chamber 11 are offset from each other in a transverse direction.

The inner conductor 24 is fixed with one end in the recess 111, preferably clamped or soldered. The sliding contact 1 with attached inner conductor 24 is guided along the loose inner conductor 24′ through the guide eye 10 of the sliding contact 1 and the stabilization chamber 11 serves as a spacer. The inner conductor 24 and the free inner conductor 24′ cannot bend even with strong bends of the high-pressure hose.

In order to reliably rule out kinking, the ratio of guide eye length 1 to stabilization chamber length L should be between ½ and ¼.

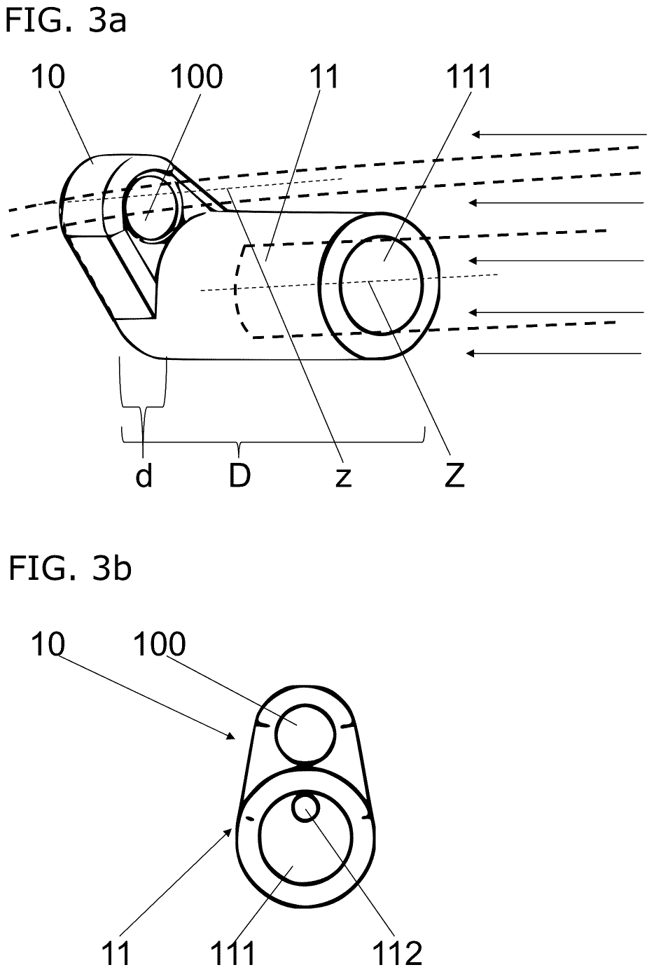

In the perspective illustration FIG. 3a, this relationship is shown again. There are no negative effects on the flow of the detergent and only minor fluid turbulence within the inner hose 21.

By choosing a small guide eye length l, the inner conductor 24′ is only guided along a short distance. Even if the loose inner conductor should have 24′ kinks, jamming of the inner conductor 24′ in guide eye 10 or in guide eye through hole 100 can be prevented due to the minimum guide eye length l. In practice, the guide eye length l ranges between 2 mm and 5 mm.

In order for cleaning fluid to escape through the recess 111

in the stabilization chamber 11 or to make soldering easier, a flow hole 112 is recessed, as indicated in FIG. 2 and shown in FIG. 3b.

The invention may be further illustrated by the following example embodiments, though the invention is not limited to such embodiments:
Embodiment 1: a sliding contact, that can be used in a multifunctional high-pressure hose of a device for inspecting and cleaning pipes and pipes, characterized in that the sliding contact is one-piece, and comprises a guide eye and a stabilization chamber made of one material, wherein the guide eye has a centric guide eye through hole with a central axis and a length, wherein the stabilization chamber has a recess designed as a blind hole running along a central axis of the stabilization chamber and both central axes are spaced parallel to each other in a transverse direction, so that an inner conductor can be attached to the stabilization chamber and a free inner conductor can be passed through the guide eye.
Embodiment 2: The sliding contact according to Embodiment 1, wherein the ratio of guide eye length to stabilization chamber length is between ½ and ¼.
Embodiment 3: The sliding contact according to any one of Embodiments 1 and 2, wherein the guide eye length is selected to be between 2 mm and 5 mm.
Embodiment 4: The sliding contact according to any one of Embodiments 1-3, wherein in the stabilization chamber a flow hole crossing the recess is recessed.
Embodiment 5: The sliding contact according to any one of Embodiments 1-4, wherein the one-piece sliding contact is made of stainless steel, preferably of V4A steel.

Embodiment 6: The sliding contact according to any one of Embodiments 1-5, wherein the inner conductor is held clamped in a recess of the stabilization chamber.
Embodiment 7: A multifunctional high-pressure hose of a device for examining and cleaning pipes and pipes, at one end of which a cleaning head with nozzles and an observation unit with illumination and camera can be attached, wherein the high-pressure hose has an inner hose, a metal braid and an outer sheath, with a sliding contact according to any one of Embodiments 1-6, characterized in that an inner conductor is fixed in the stabilization chamber of the sliding contact and the inner conductor is mounted within the inner hose by guiding the sliding contact by means of a free inner conductor through the guide eyelet through hole of the guide eye within the inner hose, whereby kinking is prevented when the high-pressure hose is bent.

Although the invention herein has been described with reference to particular embodiments, it is to be understood that these embodiments are merely illustrative of the principles and applications of the present invention. It will be apparent to those skilled in the art that various modifications and variations can be made to the method and apparatus of the present invention without departing from the spirit and scope of the invention. Thus, it is intended that the present invention include modifications and variations that are within the scope of the appended claims and their equivalents.

### LIST OF REFERENCE SIGNS

1 sliding contact
   10 guide eye (ring-shaped, as short as possible)
   100 guide eye through hole
   l Guide eye length central axis
   11 Stabilization chamber
   111 Recess
   L Stabilization chamber length
   Z central axis
   112 Flow hole ratio l/L=¼ to ½
   z and Z offset in parallel
21 Inner Hose
22 Metal Mesh
23 Outer shell
24 inner conductors
24′ free inner conductor
31 Contact ring
32 Connector
33 Crimping sleeve

1. A sliding contact that can be used in a multifunctional high-pressure hose of a device for inspecting and cleaning pipes and pipes,
characterized in that
the sliding contact is one-piece and comprises a guide eye and a stabilization chamber made of one material, wherein the guide eye has a centric guide eye through hole with a central axis and a length, and wherein the stabilization chamber has a recess configured as a blind hole running along a central axis of the stabilization chamber and both central axes are spaced parallel to each other in a transverse direction, so that an inner conductor can be attached to the stabilization chamber and a free inner conductor can be passed through the guide eye.

2. The sliding contact according to claim 1, wherein the ratio of guide eye length to stabilization chamber length is between ½ and ¼.

3. The sliding contact according to claim 1, wherein the guide eye length is selected to be between 2 mm and 5 mm.

4. The sliding contact according to claim 1, wherein in the stabilization chamber a flow hole crossing the recess is recessed.

5. The sliding contact according to claim 1, wherein the one-piece sliding contact is made of stainless steel.

6. The sliding contact according to claim 1, wherein the one-piece sliding contact is made of V4A steel.

7. The sliding contact according to claim 1, wherein the inner conductor is held clamped in a recess of the stabilization chamber.

8. A multifunctional high-pressure hose of a device for examining and cleaning pipes and pipes, at one end of which a cleaning head with nozzles and an observation unit with illumination and camera can be attached, the high-pressure hose comprising:
an inner hose,
a metal braid,
an outer sheath, and
a one-piece sliding contact comprising a guide eye and a stabilization chamber made of one material, wherein the guide eye has a centric guide eye through hole with a central axis and a length, and wherein the stabilization chamber has a recess configured as a blind hole running along a central axis of the stabilization chamber and both central axes are spaced parallel to each other in a transverse direction, so that an inner conductor can be attached to the stabilization chamber and a free inner conductor can be passed through the guide eye, wherein an inner conductor is fixed in the stabilization chamber of the sliding contact and the inner conductor is mounted within the inner hose by guiding the sliding contact by means of a free inner conductor through the guide eyelet through hole of the guide eye within the inner hose, whereby kinking is prevented when the high-pressure hose is bent.

9. The multifunctional high-pressure hose according to claim 8, wherein the ratio of guide eye length to stabilization chamber length is between ½ and ¼.

10. The multifunctional high-pressure hose according to claim 8, wherein the guide eye length is selected to be between 2 mm and 5 mm.

11. The multifunctional high-pressure hose according to claim 8, wherein in the stabilization chamber a flow hole crossing the recess is recessed.

12. The multifunctional high-pressure hose according to claim 8, wherein the one-piece sliding contact is made of stainless steel.

13. The multifunctional high-pressure hose according to claim 8, wherein the one-piece sliding contact is made of V4A steel.

14. The multifunctional high-pressure hose according to claim 8, wherein the inner conductor is held clamped in a recess of the stabilization chamber.
